(19) United States
(12) Patent Application Publication
(10) Pub. No.: US 2010/0122898 A1
(43) Pub. Date: May 20, 2010

(54) KEY BASE AND KEY SEAT

(75) Inventor: Minoru Yoshida, Niigata (JP)

Correspondence Address: HEDMAN & COSTIGAN P.C., 1185 AVENUE OF THE AMERICAS, NEW YORK, NY, 10036, US

(73) Assignee: SUNARROW LTD., Chuo-ku, Tokyo (JP)

(21) Appl. No.: 12/451,528

(22) PCT Filed: Apr. 22, 2008
(86) PCT No.: PCT/JP2008/057763

§ 371 Date: Jan. 12, 2010

(30) Foreign Application Priority Data
May 30, 2007 (JP) JP2007-144196

(51) Int. Cl. H01H 1/10

(52) U.S. Cl. 200/512

(57) ABSTRACT

There are disclosed a key base and a key sheet which are established as products even in a case where a key base main body has a flexible and elastic sheet and a presser layer is formed of electromagnetic wave curable resin integrally with the key base main body on the back surface of this key base main body. The key base according to the present invention is a key base having a key base main body, and a presser layer formed on the back surface of said key base main body, wherein said key base main body has a first sheet having flexibility and elasticity, and a second sheet which is harder than said first sheet and has the front surface thereof directly or indirectly secured to the back surface of said first sheet, above-mentioned presser layer is formed of electromagnetic wave curable resin integrally with said second sheet on the back surface of said second sheet.

### BACKGROUND OF THE INVENTION

1. Field of the Invention

The present invention relates to a key base and a key sheet for use in electronic devices such as cellular phones (including a so-called PHS), portable information terminals (personal digital assistances (PDA) or the like), portable audio devices, remote controllers for home electric appliances and keyboards.

2. Description of the Related Art

For example, in Patent Document 1, a technology is disclosed in which a key base main body is formed of a urethane sheet or a PET film (a PET sheet), and a protruding portion (a presser) made of ultraviolet (UV) curable resin is provided on the key base main body (see [0012] of the specification and FIG. 5 of Patent Document 1). Said presser is formed of the UV curable resin integrally with the key base main body on the back surface of the key base main body.

[Patent Document 1] Japanese Patent Application Laid-Open No. 6-5151

From a viewpoint of a satisfactory sense of operation during a key pressing operation, the key base main body is preferably formed of a sheet having elasticity, for example, a polyurethane sheet. However, when the key base main body is formed of the polyurethane sheet and a presser layer having the pressers is formed of electromagnetic wave curable resin such as the UV curable resin integrally with the polyurethane sheet on the back surface of this polyurethane sheet to form a key base, this polyurethane sheet is largely deformed (e.g., curled) for a reason such as contraction due to the curing of the electromagnetic wave curable resin. Therefore, it has been difficult to establish the key base and a key sheet as products. This is because the polyurethane sheet is a sheet having flexibility and elasticity. It is to be noted that as disclosed in Patent Document 1, it is also supposed that the key base main body be formed of the PET sheet instead of the polyurethane sheet. However, the PET sheet is not elastic. In a case where the key base main body is formed of the PET sheet, as compared with a case where the key base main body is formed of the polyurethane sheet, the sense of operation during the key pressing operation or the like deteriorates. Therefore, a flexible and elastic sheet such as the polyurethane sheet is to be used in the key base main body.

### SUMMARY OF THE INVENTION

The present invention has been developed in view of the above respect, and an object thereof is to provide a key base and a key sheet which are established as products even in a case where a key base main body has a flexible and elastic sheet and a presser layer is formed of electromagnetic wave curable resin integrally with the key base main body on the back surface of this key base main body.

To achieve the above-mentioned object, a key base according to the present invention is a key base comprising: a key base main body; and a presser layer formed on the back surface of said key base main body,

characterized in that said key base main body has a first sheet having flexibility and elasticity, and a second sheet which is harder than said first sheet and has the front surface thereof directly or indirectly secured to the back surface of said first sheet, and

above-mentioned presser layer is formed of electromagnetic wave curable resin integrally with said second sheet on the back surface of said second sheet.

To achieve the above-mentioned object, a key sheet according to the present invention is a key sheet comprising: a key base having a key base main body and a presser layer formed on the back surface of said key base main body; and a key top corresponding to a presser which said presser layer has and secured to the front surface of said key base,

characterized in that said key base main body has a first sheet having flexibility and elasticity, and a second sheet which is harder than said first sheet and has the front surface thereof directly or indirectly secured to the back surface of said first sheet,

above-mentioned key top is secured to the front surface of said first sheet, and

above-mentioned presser layer is formed of electromagnetic wave curable resin integrally with above-mentioned second sheet on the back surface of said second sheet.

Moreover, in above-mentioned key base or above-mentioned key sheet,

above-mentioned first sheet is a sheet in which the thermal contraction ratio of said first sheet at a temperature at which said first sheet is heated in a case where above-mentioned presser layer is formed is different from the contraction ratio of above-mentioned electromagnetic wave curable resin during the curing of said electromagnetic wave curable resin in a case where said presser layer is formed, and

above-mentioned second sheet is a sheet which does not thermally contract at said heated temperature.

Furthermore, in above-mentioned key base or above-mentioned key sheet,

above-mentioned second sheet is a non-elastic sheet.

In addition, in above-mentioned key base or above-mentioned key sheet,

above-mentioned first sheet is a polyurethane sheet, and

above-mentioned second sheet is a PET sheet.

Moreover, in above-mentioned key base or above-mentioned key sheet,

above-mentioned electromagnetic wave curable resin is UV curable resin.

Furthermore, in above-mentioned key base or above-mentioned key sheet,

above-mentioned first sheet has, substantially on the whole surface thereof, a hot melt layer to secure the key top.

In the key base or the key sheet according to the present invention, even when the key base main body has the first sheet as the sheet having the flexibility and elasticity, but the second sheet is harder than the first sheet, and the presser layer is formed on the second sheet. Therefore, as compared with a case where the presser layer is formed on the first sheet, the deformation of the key base main body can be reduced. That is, in above-mentioned key sheet or above-mentioned key base, the second sheet is interposed between the first sheet and the presser layer, whereby even when the key base main body has the sheet having the flexibility and elasticity and the presser layer is formed of the electromagnetic wave curable resin integrally with the key base main body on the back surface of this key base main body, the key base and the key sheet are established as products.

### BRIEF DESCRIPTION OF THE DRAWINGS

FIG. 1 is a perspective view showing the disassembled members of a key sheet according to one embodiment of the present invention, and a substrate where this key sheet is to be arranged;

FIG. 2 is a perspective view showing the front surface side of the key sheet according to the embodiment of the present invention;

FIG. 3 is a perspective view showing the back surface side of the key sheet according to the embodiment of the present invention;

FIG. 4 is an enlarged sectional view showing the key sheet and the substrate in a state in which the key sheet according to the embodiment of the present invention is arranged on the substrate;

FIG. 5 is an enlarged sectional view showing a key sheet and a substrate in a state in which the key sheet according to another embodiment of the present invention is arranged on the substrate;

FIG. 6 is a diagram showing a cell phone in a case where the key sheet according to the embodiment of the present invention is assembled in the cell phone; and

FIG. 7 is an explanatory view showing the steps of a key base forming method according to the embodiment of the present invention, and the outline of the steps.

### DESCRIPTION OF THE PREFERRED EMBODIMENT

One embodiment of a mode for carrying out the present invention will be described with reference to the drawings. It is to be noted that in the drawings, similar, corresponding or generic components are denoted with the same reference numerals, when described. Moreover, in a case where there are a plurality of similar, corresponding or generic components in the drawings, only a part of them is denoted with the reference numeral.

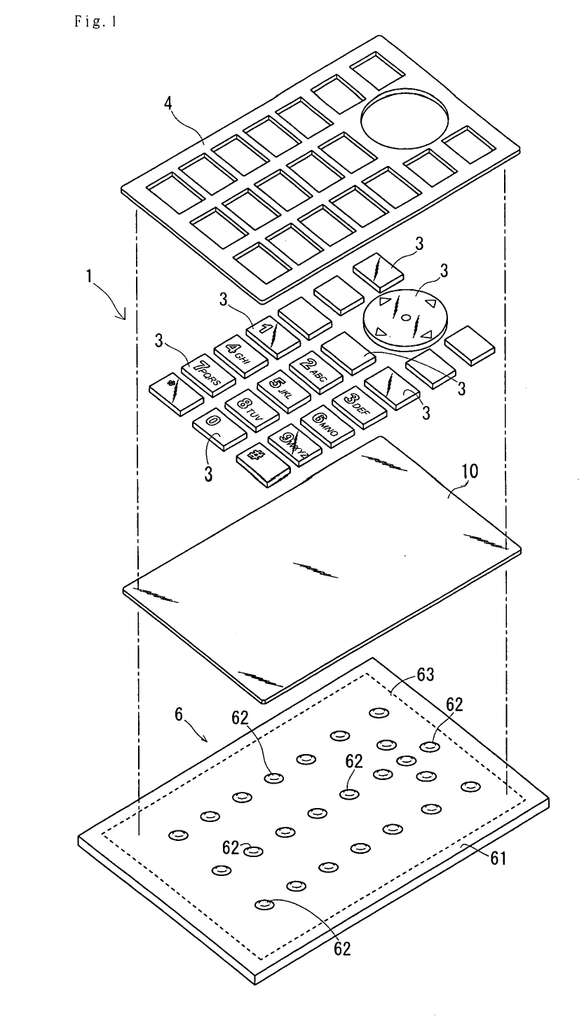

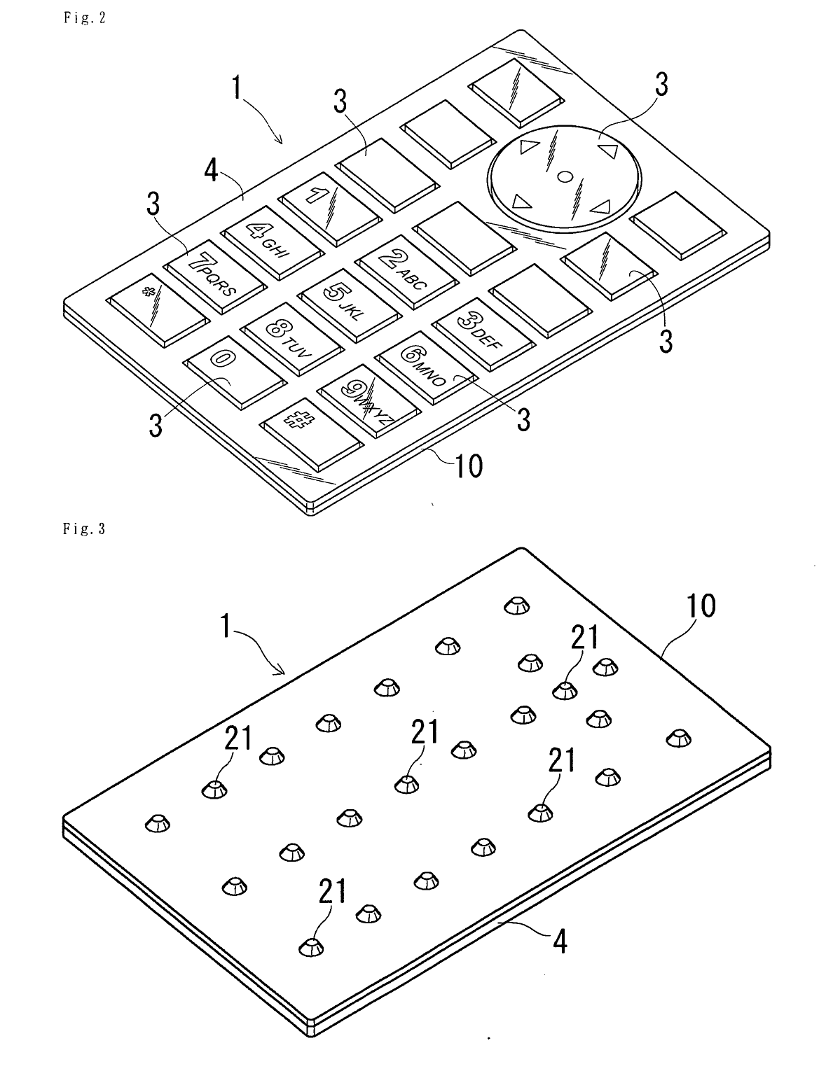

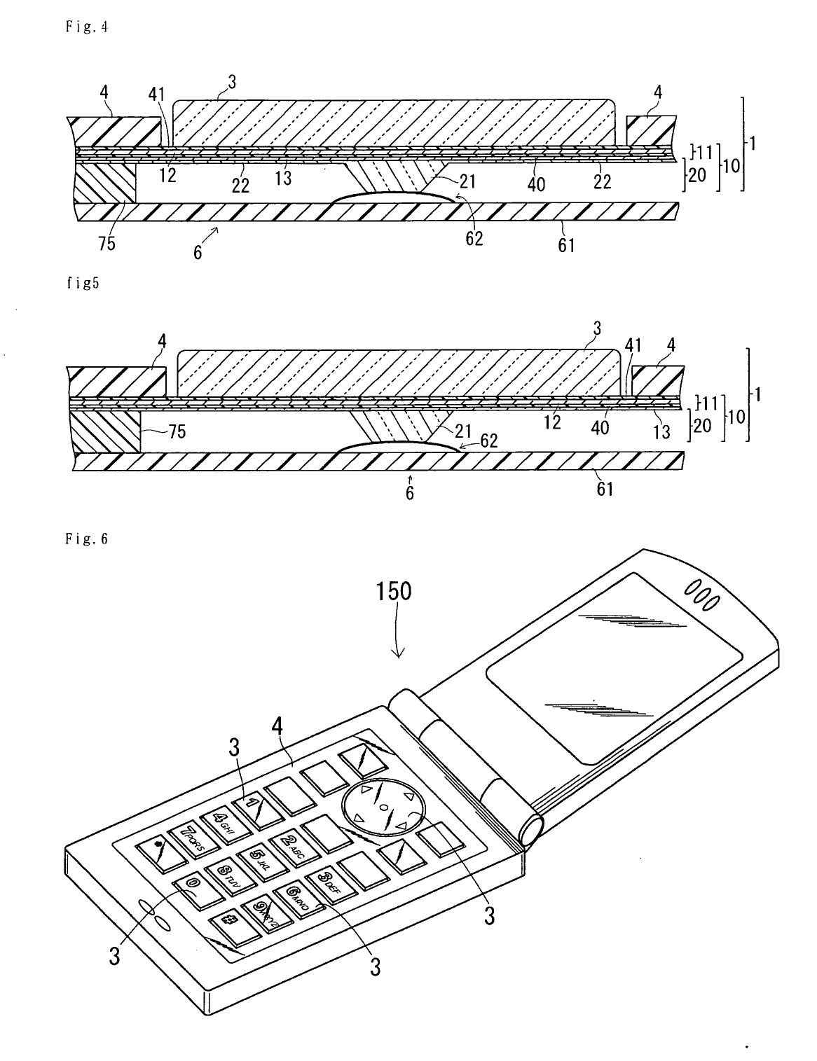

FIG. 1 is a perspective view showing the disassembled members of a key sheet according to one embodiment of the present invention, and a substrate where this key sheet is to be arranged, and FIG. 2 is a perspective view showing the front surface side of the key sheet according to the embodiment of the present invention. FIG. 3 is a perspective view showing the back surface side of the key sheet according to the embodiment of the present invention. FIG. 4 is an enlarged sectional view showing the key sheet and the substrate in a state in which the key sheet according to the embodiment of the present invention is arranged on the substrate.

A key sheet 1 has a key top 3, a cover member 4 and a key base 10. The key sheet 1 is arranged on a substrate 6.

A plurality of key tops 3 constitute keys such as a multidirectional (cursor) key, ten keys and functional keys, respectively. One or more key tops 3 may be arranged, but a plurality of key tops are usually arranged.

The cover member 4 is provided in order to reinforce the whole key sheet 1, to constitute the housing of a cell phone and so on, or the like. In a case where the key tops 3 are exposed from through holes provided for the housing of the cell phone, or the like, the cover member 4 is sometimes unnecessary. In so-called narrow pitch keys in which the key tops 3 are arranged very close to each other, the cover member 4 is sometimes unnecessary.

Moreover, the key tops 3 and the cover member 4 are sometimes integrated and formed as one plate-like member. In this case, in the plate-like member, areas where numerals, characters, symbols, patterns or the like are depicted, areas corresponding to pressers 21 and/or the like are the key tops, and another area is the cover member.

Each of the key tops 3 and the cover member 4 is formed of an appropriate material such as any type of synthetic resin (e.g., hard resin), any type of glass or a metal. The synthetic resin or the glass is basically formed of a material having a property which can transmit light. The examples of the hard resin include polyethylene terephthalate (PET), polycarbonate resin, polyurethane resin, acrylic resin and silicone resin. Moreover, on the front surface and/or the back surface of the key top 3, one or more numerals, characters, symbols, patterns, or the like are depicted by an appropriate method such as printing, painting, or the like.

The key tops 3 and the cover member 4 are formed in advance separately from the key base 10, and are secured to the front surface of the key base 10. The key tops 3 corresponding to the pressers 21 of a presser layer 20 are secured to the front surface of the key base 10 (the front surface of a key base main body 11 (the front surface of a first sheet 12)).

The key base 10 has the key base main body 11 and the presser layer 20. The key base main body 11 has the first sheet 12 and a second sheet 13. The presser layer 20 has the pressers 21 and a thin portion 22.

The first sheet 12 is a deformably elastic sheet, and a sheet having flexibility and elasticity (e.g., an elastic film sheet having the flexibility). The second sheet 13 is a sheet (e.g., a film sheet which is harder than the first sheet 12) which is harder than the first sheet 12. The second sheet 13 may be deformable or have elasticity as long as it is harder than the first sheet 12.

The first sheet 12 may appropriately be such a sheet that the thermal contraction ratio of the first sheet 12 at a temperature at which the first sheet 12 is heated in a case where the presser layer 20 is formed is different from the contraction ratio of electromagnetic wave curable resin during the curing of the electromagnetic wave curable resin in a case where the presser layer 20 is formed. The second sheet 13 may be a sheet which appropriately does not thermally contract at said heated temperature.

The second sheet 13 may appropriately be a non-elastic sheet which does not have any elasticity.

The first sheet 12 is formed of one elastic film sheet such as a thermoplastic polyurethane sheet (e.g., a thickness of about 0.05 mm) or a silicone sheet (e.g., a thickness of about 0.05 mm). The second sheet 13 is formed of one non-elastic film sheet such as a PET sheet (e.g., a thickness of about 0.025 mm).

The first sheet 12 is a sheet which is deformed in a case where the uncured electromagnetic wave curable resin brought into contact with the first sheet 12 is cured to form the presser layer 20 integrally with this first sheet 12 on the back surface of the first sheet 12. The second sheet 13 is a sheet which is not deformed as compared with the first sheet 12, in a case where the uncured electromagnetic wave curable resin brought into contact with the second sheet 13 is cured to form the presser layer 20 integrally with this second sheet 13 on the back surface of the second sheet 13.

Each of the first sheet 12 and the second sheet 13 is constituted of a single sheet (here a film sheet), but may have a structure constituted of a plurality of members, for example, a structure in which two or more sheets (especially, film sheets) are laminated. Each of the first sheet 12 and the second sheet 13 is constituted of a single film sheet to realize thinning.

The front surface of the second sheet 13 is secured to the back surface of the first sheet 12 by use of a securing layer 40 formed of an adhesive, a viscous material or the like, whereby the second sheet 13 is attached to the first sheet 12. That is, any member or the like is not interposed between the front surface of the second sheet 13 and the back surface of the first sheet 12, and the sheets are secured using the securing layer 40, whereby the front surface of the second sheet 13 is directly secured to the back surface of the first sheet 12. According to this structure, the key base main body 11 can be thinned. The key base main body 11 has the securing layer 40. Moreover, without interposing any member or the like between the front surface of the second sheet 13 and the back surface of the first sheet 12, both the sheets may directly be secured to each other by appropriate means such as a thermal fusion bonding. In this case, the key base main body 11 can be thinner. Moreover, any member, layer or the like may be interposed between the front surface of the second sheet 13 and the back surface of the first sheet 12 to secure the second sheet 13 to the first sheet 12 via the securing layer or the like. That is, the front surface of the second sheet 13 may indirectly be secured to the back surface of the first sheet 12. The front surface of the second sheet 13 is directly or indirectly secured to the back surface of the first sheet 12, before the presser layer 20 is formed.

It is to be noted that a member such as a sheet (especially, a polyurethane sheet) constituting the first sheet 12 and/or the second sheet 13 is appropriately processed. For example, a decorative layer (e.g., a light blocking layer or the like) is formed on this member by painting, printing or the like. In this case, this member appropriately has the formed decorative layer or the like. Moreover, a member such as the sheet (especially, a PET sheet) constituting the first sheet 12 and/or the second sheet 13 is appropriately subjected to any type of treatment (a primer treatment) or the like. In particular, in a case where the first sheet 12 is formed of the polyurethane sheet, the second sheet 13 is formed of the PET sheet and the front surface of the second sheet 13 is attached to the back surface of the first sheet 12, the front surface of the PET sheet may preferably be subjected to the primer treatment.

The first sheet 12 has a hot melt layer 41 for securing the key top 3 and the cover member 4 substantially on the whole surface (this is an expression including the whole surface), especially substantially on the whole surface of the front surface side. For example, the polyurethane sheet constituting the first sheet 12 as described later has the hot melt layer 41 on the whole front surface of the sheet, and further has a light blocking layer on this hot melt layer 41. The key top 3 and the cover member 4 are secured by this hot melt layer 41.

The presser layer 20 is formed on the back surface of the key base main body 11. Specifically, the presser layer 20 is formed of the electromagnetic wave curable resin integrally with the second sheet 13 on the back surface of the second sheet 13. The material of the presser layer 20 is the electromagnetic wave curable resin. In a case where the presser layer is formed of the electromagnetic wave curable resin integrally with the second sheet 13 on the back surface of the second sheet 13, it is meant that the presser layer 20 is secured to the back surface of the second sheet owing to a fusion bonding in the process of the curing of the electromagnetic wave curable resin, while the pressers 21 is formed owing to the curing of the electromagnetic wave curable resin in a case where the pressers 21 are formed. That is, the integral formation means that the presser layer 20 is secured to a member such as the second sheet 13 without using any securing material such as an adhesive or a viscous material.

The example of the electromagnetic wave curable resin is visual light curable resin, UV curable resin or the like. In particular, as the electromagnetic wave curable resin, the UV curable resin is preferable from a viewpoint of the hardness of the pressers 21, or the like. The key base or the key sheet in which the UV curable resin is used as the electromagnetic wave curable resin is excellent. The example of the UV curable resin is acrylic resin, epoxy resin, vinyl resin, silicone resin or the like.

Heretofore, when the key base main body is formed of the polyurethane sheet, a sheet-like member including the pressers and made of a silicone rubber is secured to the back surface of the polyurethane sheet to form the key base. However, in the sheet-like member formed of the silicone rubber, there has been a limit to the thinning for a reason of the fluidity, strength or the like of the silicone rubber. However, in the key base 10 and the key sheet 1, the pressers 21 are formed of the electromagnetic wave curable resin, so that such a limit is eliminated.

The thin portion 22 is formed together with the pressers 21 in a case where the presser layer 20 is formed. It is to be noted that the height of the presser 21 (a height from the lower surface of the thin portion 22 to the vertex of the presser 21) or the height of a spacer 75 described later (a height from the lower surface of the thin portion 22 to the front surface of the substrate 6 described later) needs to be the minimum height (the height of the presser 21 is, for example, 0.2 mm) for the presser 21 to press and operate a switch portion described later. Therefore, the thinning of the presser layer 20 depends on the thinness of the thin portion 22 which can be realized.

Here, FIG. 5 is an enlarged sectional view showing a key sheet and a substrate in a state in which the key sheet according to another embodiment of the present invention is arranged on the substrate

In FIG. 5, any thin portion 22 is not formed. Thus, a presser layer 20 sometimes does not have any thin portion 22. In this case, the presser layer 20 can be formed to be thinnest, and a key sheet 1 and a key base 10 can be thinned. It is to be noted that when any thin portion 22 is not formed, one or more pressers 21 only are represented as the “presser layer” 20.

Turning back to FIGS. 1 to 4, the presser layer 20 is formed by an appropriate method such as a method using a formation mold, a jig or the like or a potting method (especially shown in FIG. 5). For example, by a method described later, the presser layer 20 is formed of the electromagnetic wave curable resin integrally with the second sheet 13 on the back surface of the second sheet 13.

The substrate 6 has constitution elements such as electronic elements (not shown), a circuit (not shown) and switch portions 62 mounted on a base material 61.

Each of the switch portions 62 is constituted of a deformable member such as a metal dome or a polydome, and two short-circuit contacts (not shown) formed on the base material 61. Moreover, the deformable members are fixed by a fixing member such as a film 63 (shown by a dotted line of FIG. 1 and not shown in FIGS. 4 and 5). The film 63 is formed of PET, polycarbonate resin, or the like.

The key tops 3, the pressers 21 and the switch portions 62 are positioned so as to correspond to one another. When the key top 3 is pressed downward, the presser 21 moves downward, and the presser 21 presses the deformable member. The pressed deformable member is deformed to generate a sense of click, and come in contact with the two short-circuit contacts to short-circuit the two short-circuit contacts.

It is to be noted that the spacers 75 are appropriately arranged in the positions which are around the pressers 21 and between the key sheet 1 and the substrate 6 to prevent the influence of the movement of the key top 3 on the other key tops 3 nearby. The spacers 75 may be formed integrally with the key base main body 11 in the same manner as in the presser layer 20, or the spacers 75 formed as a separate member may be arranged between the key sheet 1 and the substrate 6. When the spacers 75 are formed integrally with the key base main body 11, for example, the spacers 75 are simultaneously formed of the same material as that of the presser layer 20. In this case, the presser layer 20 includes the spacers 75.

It is to be noted that the first sheet 12 and/or the second sheet 13 may be thickened to use the first sheet 12 and/or the second sheet 13 as a guide member (so-called light guide) of light from a predetermined light source.

In a case where the first sheet 12 is formed of one polyurethane sheet (a thickness of 0.05 mm), the second sheet 13 is formed of one PET sheet (a thickness of 0.025 mm), the thickness of the securing layer 40 is set to 0.025 mm and the thickness of the presser layer 20 is set to 0.22 mm (the thickness of the thin portion 22 is 0.02 mm and the height of the presser 21 is 0.2 mm), the key base 10 has a total thickness of 0.32 mm.

FIG. 6 is a diagram showing a cell phone in a case where the key sheet according to the embodiment of the present invention is assembled in the cell phone.

As shown in FIG. 6, a cover member 4 is integrated with the housing of a cell phone 150.

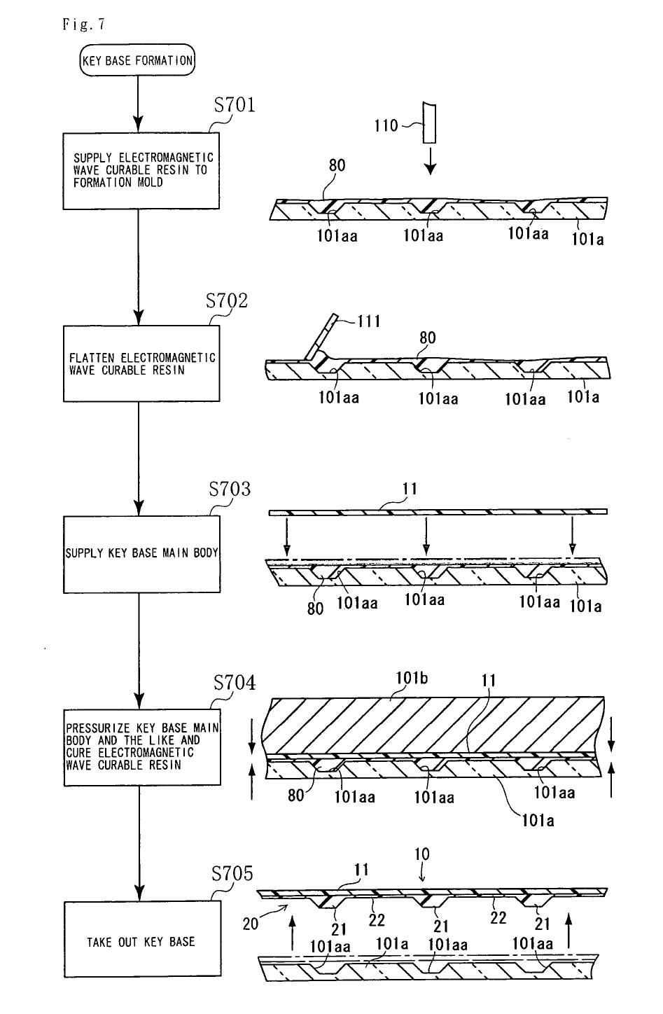

FIG. 7 is an explanatory view showing the steps of a key base forming method according to the embodiment of the present invention, and the outline of the steps.

Electromagnetic wave curable resin 80 is supplied to a formation mold 101a having concave portions 101aa in desired positions (S701).

The electromagnetic wave curable resin 80 is supplied using, for example, a dispenser (a liquid supply device), and the electromagnetic wave curable resin 80 is discharged and supplied from a discharge nozzle 110 of the dispenser.

The formation mold 101a has one or more (usually a plurality of) concave portions 101aa having a predetermined shape to provide presser 21 in desired positions. Moreover, when a spacer 75 is integrally formed, the formation mold 101a has one or more (usually a plurality of) concave portions (not shown) having a predetermined shape to provide the spacer in a desired position.

The electromagnetic wave curable resin 80 may be dropped down to the concave portions 101aa and the concave portions (not shown), individually, by use of the dispenser or the like so that the concave portions 101aa and the concave portions (not shown) only are filled. In this case, any thin portion 22 is not formed.

The electromagnetic wave curable resin 80 supplied to the formation mold 101a is flattened (S702).

As shown in FIG. 7, a squeegee 111 is allowed to run on the electromagnetic wave curable resin 80. It is to be noted that at this time, the electromagnetic wave curable resin 80 other than the electromagnetic wave curable resin 80 accumulated in the concave portions 101aa and the concave portions (not shown) is all removed using the squeegee 111, and then any thin portion 22 is not formed. Moreover, even if all of the electromagnetic wave curable resin 80 other than the accumulated electromagnetic wave curable resin 80 in the concave portions 101aa and the concave portions (not shown) is not removed, at this time, the unnecessary electromagnetic wave curable resin 80 can be removed, and the thin portion 22 can be thinned. It is to be noted that the squeegee 111 may appropriately be changed to a doctor blade, a roller or the like as long as the electromagnetic wave curable resin 80 is flattened.

The key base main body 11 is supplied to the formation mold 101a to which the electromagnetic wave curable resin 80 has been supplied so that the back surface of the key base main body 11 faces downward (S703).

Before or during the curing of the electromagnetic wave curable resin 80, the electromagnetic wave curable resin 80 and the key base main body 11 are pressurized from the thickness direction of the key base main body 11, and the electromagnetic wave curable resin 80 is cured (S704).

Moreover, the electromagnetic wave curable resin 80 may be heated at a low temperature (e.g., about 80° C. in a case where the electromagnetic wave curable resin is UV curable resin) before curing the electromagnetic wave curable resin 80, in order to prevent the generation of bubbles during the curing of the electromagnetic wave curable resin 80 by lowering the viscosity of the uncured electromagnetic wave curable resin 80. In this case, the key base main body 11 which comes in contact with the heated electromagnetic wave curable resin is also heated. Furthermore, during the supplying of the key base main body 11, the key base main body 11 is sometimes pulled from opposite ends so that the deflection of the key base main body 11 is prevented to easily form the presser layer 20.

The electromagnetic wave curable resin 80 and the key base main body 11 are pressurized from the thickness direction by the formation mold 101a and a formation mold 101b. This pressurizing can allow the unnecessary electromagnetic wave curable resin 80 to overflow between the formation mold 101a and the formation mold 101b, and the thin portion 22 can be thinned. If the pressure during the pressurizing is high, the thin portion 22 can further be thinned.

Furthermore, after the pressurizing, the electromagnetic wave curable resin 80 is cured. For example, the upper surface of the formation mold 101a and/or the lower surface of the formation mold 101b is glass or the like, and an electromagnetic wave generation device (a UV lamp in a case where the electromagnetic wave curable resin 80 is UV curable resin) is provided at the downside or upside of this glass. Then, the electromagnetic wave curable resin 80 is irradiated with electromagnetic waves (ultraviolet rays in a case where the electromagnetic wave curable resin 80 is the UV curable resin) to cure the electromagnetic wave curable resin 80. During the pressurizing, the electromagnetic wave curable resin 80 may be irradiated with the electromagnetic waves to cure this electromagnetic wave curable resin 80. It is to be noted that the curing (a curing reaction) of a material might be disturbed by the pressurizing, depending on the type of the electromagnetic wave curable resin 80. Therefore, the material is sometimes cured after the pressurizing, depending on the type of the material.

When the electromagnetic wave curable resin 80 is cured, the electromagnetic wave curable resin 80 in the concave portions 101aa constitutes the pressers 21. Moreover, the other electromagnetic wave curable resin 80 constitutes the thin portions 22. Then, when the electromagnetic wave curable resin 80 is cured, the electromagnetic wave curable resin 80 is integrated with the key base main body 11 (the second sheet 13). During the curing of the electromagnetic wave curable resin, contraction occurs owing to the curing of the electromagnetic wave curable resin. The key base main body 11 is sometimes influenced by this contraction. When the key base main body 11 is formed of the first sheet 12 only, the key base main body 11 is sometimes largely deformed with this contraction.

The electromagnetic wave curable resin 80 is cured, and then the key base 10 is taken out to complete the key base 10 (S705).

When the electromagnetic wave curable resin 80 is cured, the presser layer 20 is formed of the electromagnetic wave curable resin 80 integrally with the second sheet 13 on the back surface of the second sheet 13.

When the electromagnetic wave curable resin 80 is used in the presser layer 20, during the formation of the presser layer 20, the heating does not have to be performed. Alternatively, even when the resin is heated, the resin may be heated at the low temperature. Therefore, the first sheet 12 (especially, the polyurethane sheet) and/or the second sheet 13 of the key base main body 11 is not adversely affected. When the first sheet 12 is provided with the hot melt layer 41 in advance, the hot melt layer 41 can be prevented from changing in quality.

It is to be noted that the first sheet 12 is a sheet having flexibility and elasticity, and the second sheet 13 is a sheet harder than the first sheet 12. In the key sheet 1 or the key base 10, the presser layer 20 is formed on the second sheet 13 which is harder than the first sheet 12, so that the deformation of the key base main body 11 due to the contraction caused by the curing of the electromagnetic wave curable resin during the formation of the presser layer 20 can be reduced as compared with the presser layer 20 is formed integrally with the first sheet 12. That is, the second sheet 13 is interposed between the first sheet 12 and the presser layer 20, whereby even when the key base main body 11 has a sheet having the flexibility and elasticity and the presser layer 20 is formed of the electromagnetic wave curable resin integrally with the key base main body 11 on the back surface of the key base main body 11, the key sheet 1 or the key base 10 is the key sheet or the key base established as a product.

Moreover, in a case that when the presser layer 20 is formed of the electromagnetic wave curable resin integrally with the key base main body 11 on the back surface of this key base main body 11, the electromagnetic wave curable resin 80 is heated at a low temperature (e.g., about 80° C. in a case where the electromagnetic wave curable resin is UV curable resin) in order to prevent the generation of bubbles during the curing of the electromagnetic wave curable resin 80 by lowering the viscosity of the uncured electromagnetic wave curable resin 80, the key base main body 11 which comes in contact with the heated electromagnetic wave curable resin is also heated. In a case where this presser layer 20 is formed, when the first sheet 12 only constitutes the key base main body 11, the first sheet 12 is heated to thermally contract. Moreover, when this presser layer 20 is formed, the electromagnetic wave curable resin is cured and hence contracts. At this time, the thermal contraction ratio of the first sheet 12 (the thermal contraction ratio of this first sheet 12 at the temperature at which the first sheet 12 is heated during the formation of the presser layer 20) is different from the contraction ratio during the curing of the electromagnetic wave curable resin (the contraction ratio of the electromagnetic wave curable resin during the curing of the electromagnetic wave curable resin in a case where the presser layer 20 is formed), so that the key base 10 is deformed. In a case where the second sheet 13 is a sheet which does not thermally contract at said temperature at which the second sheet 13 is heated, the second sheet 13 is not deformed at said heated temperature. Therefore, owing to the presence of the second sheet, the key sheet 1 or the key base 10 is the key sheet or the key base which can be established as a product.

It is to be noted that in a case where it is described that the sheet “does not thermally contract”, this description includes not only a case where the sheet completely does not thermally contract but also a case where the sheet slightly contracts to such an extent that the degree of the contraction can be ignored.

Furthermore, when the presser layer 20 is formed of the electromagnetic wave curable resin integrally with the key base main body 11 on the back surface of this key base main body 11, to prevent the deflection of the key base main body 11 and facilitate the forming of the presser layer 20, the key base main body 11 is sometimes pulled from the opposite ends. Thus, in a case where the key base main body 11 is constituted of the first sheet 12 only and the first sheet 12 has the elasticity, when the key base main body 11 is pulled, the key base main body 11 expands, and the key base main body 11 contracts after the formation of the presser layer 20. It is also supposed that the contraction of this key base main body 11 sometimes causes the deformation of the key base 10. Even in a case where the first sheet 12 is an elastic sheet, when the second sheet 13 is non-elastic sheet, the expansion and contraction of this key base main body 11 can be suppressed. Therefore, the key sheet 1 or the key base 10 constitutes the key sheet or the key base established as a product. Moreover, when the first sheet 12 has the elasticity and the second sheet 13 is not elastic, a poor sense of operation in a case where the key base main body 11 is formed of the non-elastic sheet can be compensated by the elasticity of the first sheet 12.

As described above, in the key base 10 and the key sheet 1 in which the key base main body 11 has the first sheet 12 and the second sheet 13, the defect of the first sheet 12 can be compensated by the second sheet 13, and the defect of the second sheet 13 can be compensated by the first sheet 12.

Moreover, it is preferable that the first sheet 12 is formed of the polyurethane sheet and that the second sheet 13 is formed of the PET sheet. The UV curable resin is preferably used as the electromagnetic wave curable resin.

With respect to the polyurethane sheet, there are many securing materials such as an adhesive and a viscous material that have satisfactory compatibility (that can easily be secured). Therefore, when the first sheet 12 is the polyurethane sheet, the key top 3 and the cover member 4 can be secured to this polyurethane sheet by use of a securing layer using this securing material having the satisfactory compatibility such as the hot melt layer. In consequence, the key top 3 (especially made of polycarbonate resin) and the cover member 4 (especially made of polycarbonate resin) can firmly be secured to the front surface of the key base. Moreover, with respect to the polyurethane sheet, there are many materials having satisfactory compatibility, for example, ink, whereby the polyurethane sheet facilitates processing such as the forming of a decorative layer (e.g., a light blocking layer or the like) on the front surface of this polyurethane sheet by printing or the like. Thus, the polyurethane sheet has many advantages in a case where the sheet is used as the constitution element of the key base 10. Therefore, it is supposed that the polyurethane sheet is preferable as the first sheet 12.

The PET sheet is not easily subjected to the above-mentioned processing as compared with the polyurethane sheet. Moreover, owing to the reason that there is not any or many securing materials having satisfactory compatibility with the PET sheet, to the property of the PET sheet itself, and the like, the securing strength between the PET sheet and the key top is smaller than that between the polyurethane sheet and the key top. However, the PET sheet has properties that the PET sheet is harder than the polyurethane sheet and that the PET sheet does not thermally contract (has a small contraction ratio) at a temperature at which the sheet is heated during the formation of the presser layer 20. The PET sheet also has the non-elastic property and the like. Therefore, even in a case where the presser layer 20 is formed of the UV curable resin integrally with the PET sheet on the back surface of the PET sheet, as compared with a case where the layer is formed on a urethane sheet, the deformation of the key base 10 can be reduced. In consequence, the PET sheet is preferable as the second sheet 13.

As described above, in the key base 10 or the key sheet 1 in which the first sheet 12 is formed of the polyurethane sheet, the second sheet 13 is formed of the PET sheet and the electromagnetic wave curable resin is the UV curable resin, the defect of the polyurethane sheet can be compensated by the PET sheet, and the defect of the PET sheet can be compensated by the polyurethane sheet. That is, in this key base 10 or key sheet 1, even in a case where the key base main body 11 has the polyurethane sheet and the presser layer 20 is formed of the UV curable resin integrally with the key base main body 11 on the back surface of the key base main body 11, there can be provided the remarkably excellent key base 10 or key sheet 1 provided with the following advantages; the key base or the key sheet can be established as a product; the key tops 3 can firmly be secured to the front surface of the key base; the front surface of the key base main body is easily processed; the key base or key sheet can be thinned; the pressers 21 having a satisfactory hardness or the like can be obtained; and the like.

Moreover, the first sheet 12 has, substantially on the whole surface thereof, the hot melt layer 41 for securing the key tops 3 and the cover member 4, whereby the whole back surface of the key top 3 or the cover member 4 can be secured to the front surface of the first sheet, and any gap is not generated between the key top 3 or the cover member 4 and the first sheet 12 (the whole back surface of the key top 3 or the cover member 4 can be bonded to the first sheet 12). Therefore, it can be prevented that the key top 3 or the cover member 4 peels from this gap. Moreover, a sheet (e.g., the polyurethane sheet provided with the hot melt layer 41 as described later) provided with the hot melt layer 41 on the whole front surface thereof and having the flexibility is commercially available. When this sheet is used, a step of forming the hot melt layer 41 can be omitted. Moreover, the hot melt layer 41 is formed on the side of the first sheet 12, whereby the viscous material or the like does not have to be used in securing the cover member 4. This facilitates the forming of the key sheet 1. When the hot melt layer is formed on the back surface of the key top 3 or the cover member 4, the step of forming the hot melt layer become complicated as the hot melt layer need to be formed on the respective key tops 3 and cover member 4. However, when the hot melt layer 41 is formed on the side of the first sheet 12, or the sheet provided with the hot melt layer 41 on the whole front surface thereof and having the flexibility is used, the step of forming the hot melt layer can be simplified or omitted.

The key sheet according to the present invention is not limited to above-mentioned embodiment only, and needless to say, above-mentioned embodiment can appropriately be modified without departing from the scope of the present invention.

What is claimed is:

1. A key base comprising: a key base main body; and a presser layer formed on the back surface of said key base main body,
wherein said key base main body has a first sheet having flexibility and elasticity, and a second sheet which is harder than said first sheet and has the front surface thereof directly or indirectly secured to the back surface of said first sheet, and
above-mentioned presser layer is formed of electromagnetic wave curable resin integrally with said second sheet on the back surface of said second sheet.

2. A key sheet comprising: a key base having a key base main body and a presser layer formed on the back surface of said key base main body; and a key top corresponding to a presser which said presser layer has and secured to the front surface of said key base,
wherein said key base main body has a first sheet having flexibility and elasticity, and a second sheet which is harder than said first sheet and has the front surface thereof directly or indirectly secured to the back surface of said first sheet,
above-mentioned key top is secured to the front surface of said first sheet, and
above-mentioned presser layer is formed of electromagnetic wave curable resin integrally with above-mentioned second sheet on the back surface of said second sheet.

3. The key base according to claim 1 or the key sheet according to claim 2,
wherein above-mentioned first sheet is a sheet in which the thermal contraction ratio of said first sheet at a temperature at which said first sheet is heated in a case where above-mentioned presser layer is formed is different from the contraction ratio of above-mentioned electromagnetic wave curable resin during the curing of said electromagnetic wave curable resin in a case where said presser layer is formed, and
above-mentioned second sheet is a sheet which does not thermally contract at said heated temperature.

4. The key base or the key sheet according to any one of claims 1 to 3,
wherein above-mentioned second sheet is a non-elastic sheet.

5. The key base or the key sheet according to any one of claims 1 to 4,
wherein above-mentioned first sheet is a polyurethane sheet, and
above-mentioned second sheet is a PET sheet.

6. The key base or the key sheet according to any one of claims 1 to 5,
wherein above-mentioned electromagnetic wave curable resin is UV curable resin.

7. The key base or the key sheet according to any one of claims 1 to 6,
wherein above-mentioned first sheet has, substantially on the whole surface thereof, a hot melt layer to secure the key top.
